(19) United States
(12) Patent Application Publication
(10) Pub. No.: US 2022/0177265 A1
(43) Pub. Date: Jun. 9, 2022

(54) VOICE ACTIVATED ELEVATOR SYSTEM INTERFACE THAT PROVIDES A CUSTOMIZED RESPONSE

(71) Applicant: OTIS ELEVATOR COMPANY, Farmington, CT (US)

(72) Inventors: Arthur HSU, South Glastonbury, CT (US); Stephen Richard NICHOLS, Plantsville, CT (US); Harrison DANIELS, Avon, CT (US)

(21) Appl. No.: 17/112,898

(22) Filed: Dec. 4, 2020

(51) Int. Cl. B66B 1/46; B66B 3/00

(52) U.S. Cl. CPC B66B 1/468; B66B 2201/4661; B66B 2201/4646; B66B 3/008

(57) ABSTRACT

An illustrative example embodiment of an elevator system interface includes a voice-activated input that is configured to receive audible input from a user. A processor is configured to determine a response to the audible input based on a content of the audible input and at least one other factor. An output provides at least an audible indication of the determined response.

### BACKGROUND

For many years, elevator systems have included hall call buttons that allow a passenger to indicate a desire to travel up or down. The system responds by sending an elevator car to the location of the passenger. Once onboard the elevator car, the passenger can select a destination floor using a car operating panel that typically includes a set of buttons corresponding to the available floors.

Over time, different technologies have allowed for different types of interfaces for elevator passengers to interact with the elevator system to request service. For example, more recently, destination entry systems have been developed that include an interface, such as a kiosk, where a passenger can enter a desired destination before boarding an elevator car. The elevator system responds to such a request by assigning a car to carry the passenger to the intended destination and notifies the passenger which car to board. The passenger need not, and typically cannot, enter a destination from inside the elevator car in such systems.

Different types of passenger interfaces, whether inside or outside an elevator car, present unique challenges and opportunities to improve interactions with an elevator system and the system response.

### SUMMARY

An illustrative example embodiment of an elevator system interface includes a voice-activated input that is configured to receive audible input from a user. A processor is configured to determine a response to the audible input based on a content of the audible input and at least one other factor. An output provides at least an audible indication of the determined response.

In addition to one or more of the features described above, or as an alternative, the processor is configured to determine at least one characteristic of the audible indication of the response selected from a set of characteristics consisting of a language, an accent, a speech tempo, and a volume.

In addition to one or more of the features described above, or as an alternative, the processor is configured to determine the at least one characteristic of the audible indication based on a corresponding characteristic of the audible input.

In addition to one or more of the features described above, or as an alternative, the at least one other factor is a language of the audible input.

In addition to one or more of the features described above, or as an alternative, the at least one other factor is a time or an event on a predetermined schedule.

In addition to one or more of the features described above, or as an alternative, the at least one other factor is a characteristic of a passenger request included in the audible input and the characteristic is selected from a set of characteristics consisting of a direction of travel, an origination floor, and an intended destination.

In addition to one or more of the features described above, or as an alternative, the at least one other factor includes a characteristic of the user and the characteristic of the user is selected from a set of characteristics consisting of a voice signature, a biometric feature of the user, an item carried by the user, and an item worn by the user.

In addition to one or more of the features described above, or as an alternative, the at least one other factor includes an authorization of the user and the response includes providing the user access to at least one secured feature of the elevator system corresponding to the authorization of the user.

In addition to one or more of the features described above, or as an alternative, the processor is configured to determine a type of authorization of the user, the type of authorization is one of an elevator system specialist, a building manager, and a priority passenger. When the type of authorization is the elevator system specialist, the secured feature includes at least one of an elevator system function, information regarding performance of at least one portion of the elevator system, maintenance information, and control over at least one portion of the elevator system. When the type of authorization is the building manager, the secured feature includes at least one of predetermined floor access, service information and customization options. When the type of authorization is the priority passenger, the secured feature includes at least one of priority elevator car assignment, predetermined floor access, a comfort feature, and an entertainment feature.

In addition to one or more of the features described above, or as an alternative, the processor is configured to determine the type of authorization of the user based on at least a voice signature of the user input or a predetermined authorization code of the user input and the at least one other secured feature includes a voice command or is accessible in response to a voice command.

An illustrative example embodiment of a method of operating an elevator system interface includes receiving audible input from a user at the interface, determining a response to the audible input based on a content of the audible input and at least one other factor, and providing at least an audible indication of the determined response through the interface.

In addition to one or more of the features described above, or as an alternative, the method includes determining the at least one other factor based on at least one characteristic of the audible indication of the response selected from a set of characteristics consisting of a language, an accent, a speech tempo, and a volume.

In addition to one or more of the features described above, or as an alternative, the method includes determining the at least one characteristic based on a corresponding characteristic of the audible input.

In addition to one or more of the features described above, or as an alternative, the at least one other factor is a language of the audible input.

In addition to one or more of the features described above, or as an alternative, the at least one other factor is a time or an event on a predetermined schedule.

In addition to one or more of the features described above, or as an alternative, the at least one other factor is a characteristic of a passenger request included in the audible input and the characteristic is selected from a set of characteristics consisting of a direction of travel, an origination floor, and an intended destination.

In addition to one or more of the features described above, or as an alternative, the at least one other factor includes a characteristic of the user and the characteristic of the user is selected from a set of characteristics consisting of a voice signature, a biometric feature of the user, an item carried by the user, and an item worn by the user.

In addition to one or more of the features described above, or as an alternative, the at least one other factor includes an authorization of the user and the method includes providing the user access to at least one secured feature of the elevator system corresponding to the authorization of the user.

In addition to one or more of the features described above, or as an alternative, the method includes determining a type of authorization of the user and wherein the type of authorization is one of an elevator system specialist, a building manager, and a priority passenger. When the type of authorization is the elevator system specialist, the secured feature includes at least one of an elevator system function, information regarding performance of at least one portion of the elevator system, maintenance information, and control over at least one portion of the elevator system. When the type of authorization is the building manager, the secured feature includes at least one of predetermined floor access, service information and customization options. When the type of authorization is the priority passenger, the secured feature includes at least one of priority elevator car assignment, predetermined floor access, a comfort feature, and an entertainment feature.

In addition to one or more of the features described above, or as an alternative, the method includes determining the type of authorization of the user based on at least a voice signature of the user input or a predetermined authorization code of the user input, and wherein the at least one other secured feature includes a voice command or is accessible in response to a voice command.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an example embodiment of an elevator user interface that is configured to receive audible input from a user.

FIG. 2 is a flowchart diagram summarizing a method of controlling a user interface like that shown in FIG. 1.

### DETAILED DESCRIPTION

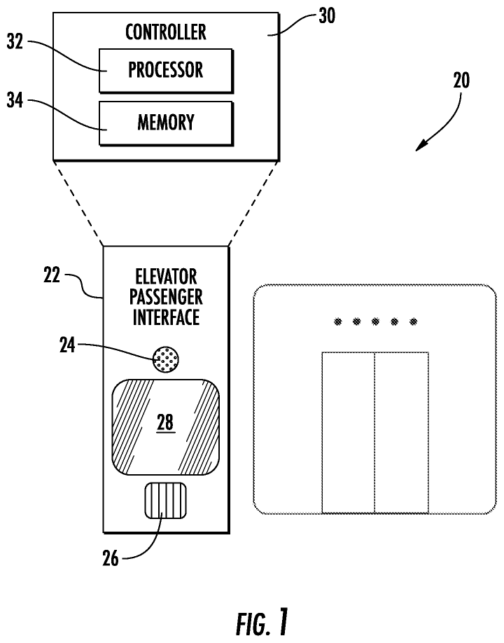

FIG. 1 schematically illustrates an elevator system interface 20 including an user interface 22 that is configured to receive audible user input, such as requests for elevator service or access to a system function. The user interface 22 in this example is voice-activated and capable of receiving spoken elevator service requests. For example, a nearby passenger can state a request for elevator service indicating a desired direction of travel or an intended destination. The example user interface 22 includes an input 24, such as a microphone or a sound detector, to receive audible input. The user interface 22 includes an output 26, such as a speaker, that provides an audible response based on the audible input. The example user interface 22 also includes a display, such as a touchscreen, that may be used to facilitate user input or to provide a visible output based on received input, such as an indication of an elevator car assigned to a passenger request for service or a menu of features accessible to an authorized individual.

A controller 30 is associated with the user interface 22. The controller 30 includes a processor 32 that is configured to determine a response to audible input from a user of the user interface 22. In this example, the processor 32 has associated memory 34 that contains or at least temporarily stores information, such as computer-executable instructions that cause the processor 32 to perform operations consistent with those described here. The memory 34 in some examples includes a database of information regarding users of the interface 22, such as voice signatures from previous interactions with the user interface 22.

The controller 30 may be a dedicated computing device associated with the user interface 22 or may be at least a portion of a controller used for other features or functions of the elevator system. The processor 32 and memory 34 are shown schematically and do not require any particular physical arrangement of components. For example, some or all of the processor 32 and some or all of the memory 34 may be realized through a cloud computing arrangement located remotely from the elevator system.

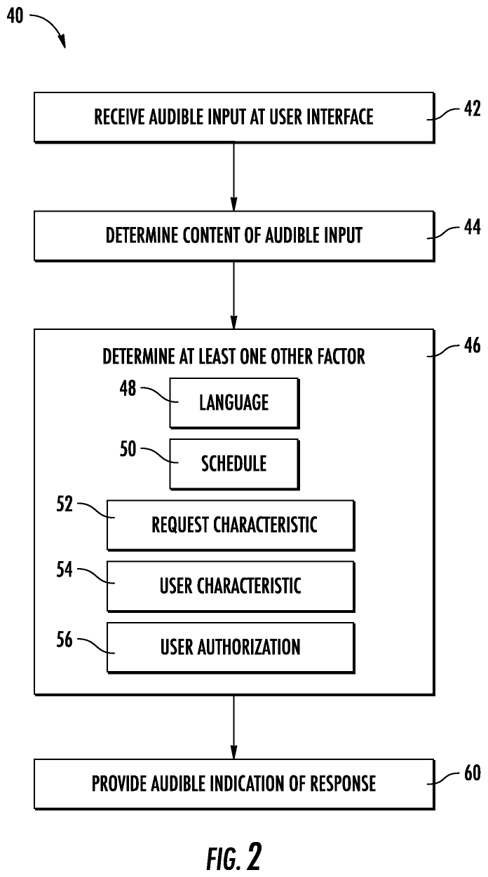

FIG. 2 is a flowchart diagram 40 that summarizes an example technique for controlling the interface 22 including processing and responding to input received at the user interface 22. At 42, audible input is received through the input 24. For example, an individual speaks a request or command that is detected by the microphone or sound detector of the input 24. At 44, the processor 32 determines content of the received audible input. Determining the content may include, for example, interpreting spoken words or recognizing a particular phrase or command. The processor 32 utilizes the determined content of the audible input and information from the memory 34 to determine an appropriate response from the user interface 22 and, when necessary, the elevator system.

The response provided through the user interface 22 is determined in part based on at least one other factor at 46. The processer 32 in the illustrated example embodiment is configured to consider at least one of a plurality of factors that can influence or dictate the way in which a response is provided by the user interface 22. Several example factors are illustrated in FIG. 2. The processor 32 may use all or only a subset of the example factors.

At 48, the processor 32 determines a language of the audible input. That language is used to set or determine a language of any audible indication of the determined response through the speaker 26, for example. Considering the language of the received input as a factor for determining the response provides an enhanced user experience because a user will receive a response in the same language that the user spoke when providing the input to the interface 22. Considering the language at 48 may include determining the language itself, recognizing an accent of the user, mimicking a speech tempo of the user or selecting a type of voice depending on the type of voice of the input.

Another factor considered by the processor 32 in this example includes a predetermined time or event on a schedule 50. The time of day, day of week or other calendar event may influence or determine at least part of the response to the audible input. For example, on a recognized holiday, the response may include a holiday greeting or wish that is commonly used in a particular language or within a particular region. Other schedule factors include the time of day, which may lead the processor 32 to include a morning greeting welcoming the user to the building or wishing the user a nice evening near the end of the day.

Another example factor shown in FIG. 2 is a characteristic of a request at 52. When the user makes a request for elevator service, for example, the characteristic of that request may influence or dictate at least part of the audible indication provided regarding the response of the system to the request. The origination floor or intended destination and the direction of travel are example characteristics of a request that can be used by the processor 32 to customize the response. For example, when the intended destination floor includes a restaurant that is having a special, the audible indication may alert the passenger to the special of the day. In another example, the boarding or origination floor is where the passenger works each day and the destination floor is the building lobby. In that case, the audible indication may include wishing the passenger a nice evening or a safe trip home.

At 54, a user characteristic is another example factor that may be taken into account by the processor 32 for customizing the response of the user interface 22. Example user characteristics include biometric features of a user, such as facial features, height, hair color, or a voice signature. Although not specifically illustrated, an appropriate biometric feature sensor may be included to recognize certain biometric features of a user. A camera may be used with facial recognition technology, for example, to recognize an individual and to customize the response according to a preselected preference of the passenger. Another example user characteristic includes an aspect of the user's voice. For example, when a user's voice is recognized as belonging to an elderly person, the response provided by the user interface 22 may include an increased volume to assist that user in hearing the response. Other example user characteristics include an item that is carried by or worn by the individual user and recognized by the processor 32 as an indicator of a particular individual or group for which a particular customized response should be provided.

Another user characteristic may include a recognition of other voices associated with the voice of the individual issuing a command or making a request through the input 24. In some example embodiments, the processor 32 configures the response to include a question whether other individuals whose voices have been detected will accompany a user on an intended trip to an intended destination, for example. Another situation in which the user characteristic may be associated with a group or additional passengers is when an individual is recognized as someone who routinely travels with family members or co-workers, for example. When such a user characteristic is recognized at 54, the response may include a question or an indication regarding another individual accompanying the user at that time. When suitable or necessary, the response or an additional response may also indicate that more than one elevator car will be coming to carry the passengers. Customizing the response of the user interface 22 in this way not only personalizes the response for the user but facilitates more efficiently assigning elevator cars to carry passengers and ensuring adequate room in an elevator car for those who intend to travel together.

Another example factor used in the illustrated example is a user authorization at 56. In some instances, different users will have different authorizations to receive different types of responses from the user interface 22. For example, a priority passenger may have access to specialized services, such as a dedicated elevator car, access to particular levels in a building, or access to a comfort or entertainment feature while on board an elevator car. The response of the user interface 22 provided by the processor 32 to a priority passenger may include an announcement of such features being available or may enable such features for the individual user to then provide additional input requesting use of or access to such features. For example, a user recognized as a priority passenger may receive output from the user interface 22 recognizing that individual by greeting her by name. At that time the user is able to issue additional commands or requests that are not available to other non-priority passengers. For example, a priority passenger may be able to request express service without any intervening stops, to have an elevator car assigned only to that passenger, or to travel to a floor with limited or restricted access.

Another example authorized user includes a building manager who is responsible for various aspects of the building in which the elevator system is located. A building manner may obtain access to secured features including predetermined floor access, service information regarding the elevator system, and customization options. For example, a building manager may be able to customize the appearance of the display 28 depending on a particular season or an event that is occurring in the building where the elevator system is located. When the building manager user authorization is determined by the processor 32, the set of secured features, such as additional voice commands, are made available to that user.

Another example user authorization is for an elevator specialist, such as a mechanic or technician. Secured features available to an elevator specialist include elevator system functions, such as directing a car to a particular floor, performing testing, or placing the elevator system into a maintenance or inspection mode. Additional secured features available to an elevator specialist include providing access to information regarding performance of at least one portion of the elevator system. Such information may be provided on the display 28 or be provided audibly through the speaker 26, for example. Additionally, an elevator specialist may be able to input maintenance or performance information through the interface 22, which may be stored in the memory 34 to be accessible to an elevator system provider, for example, or to establish use and maintenance history information regarding the elevator system.

In the illustrated example embodiment, the processor 32 is configured to determine the type of authorization of a user based on at least a voice signature of the user input. Additionally or optionally a predetermined authorization code of the user may be provided through the user input by, for example, speaking a password into the input 24. The type of authorization of a user may also be determined based upon an additional factor, such as a security badge, token or key.

By recognizing certain users as being authorized for particular or secured features, additional voice command or request options may be made available and additional types of responses can be provided depending on the individual's particular authorization.

The various factors considered at 46 in FIG. 2 may be considered individually or in any combination of more than one of them. These factors provide for relatively sophisticated and customizable responses to user input that makes the user interface 22 versatile and effective for a large variety of situations if desired.

At 60, the user interface 22 provides an audible indication of the response through the speaker 26. A visual indication may also be provided on the display 28. The indication of the response may include, for example, elevator car assignment information, expected wait time information, news, advertising, or particular information that has been predetermined to be potentially of use or interest to an individual user.

The disclosed example system and method enhance a user's experience with a voice-activated elevator system interface. The response provided by the user interface 22 may be customized in a variety of manners and provide useful information to a variety of individuals under a variety of circumstances. Various combinations and sub-combinations of the features described above are used in different embodiments.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator system interface, comprising:
a voice-activated input that is configured to receive audible input from a user;
a processor that is configured to determine a response to the audible input based on a content of the audible input and at least one other factor; and
an output that is configured to provide at least an audible indication of the determined response.

2. The elevator system interface of claim 1, wherein the processor is configured to determine at least one characteristic of the audible indication of the response selected from a set of characteristics consisting of a language, an accent, a speech tempo, and a volume.

3. The elevator system interface of claim 2, wherein the processor is configured to determine the at least one characteristic of the audible indication based on a corresponding characteristic of the audible input.

4. The elevator system interface of claim 1, wherein the at least one other factor is a language of the audible input.

5. The elevator system interface of claim 1, wherein the at least one other factor is a time or an event on a predetermined schedule.

6. The elevator system interface of claim 1, wherein
the at least one other factor is a characteristic of a passenger request included in the audible input, and
the characteristic is selected from a set of characteristics consisting of a direction of travel, an origination floor, and an intended destination.

7. The elevator system interface of claim 1, wherein
the at least one other factor includes a characteristic of the user; and
the characteristic of the user is selected from a set of characteristics consisting of a voice signature, a biometric feature of the user, an item carried by the user, and an item worn by the user.

8. The elevator system interface of claim 1, wherein
the at least one other factor includes an authorization of the user, and
the response includes providing the user access to at least one secured feature of the elevator system corresponding to the authorization of the user.

9. The elevator system interface of claim 8, wherein
the processor is configured to determine a type of authorization of the user;
the type of authorization is one of an elevator system specialist, a building manager, and a priority passenger;
when the type of authorization is the elevator system specialist, the secured feature includes at least one of an elevator system function, information regarding performance of at least one portion of the elevator system, maintenance information, and control over at least one portion of the elevator system;
when the type of authorization is the building manager, the secured feature includes at least one of predetermined floor access, service information and customization options; and
when the type of authorization is the priority passenger, the secured feature includes at least one of priority elevator car assignment, predetermined floor access, a comfort feature, and an entertainment feature.

10. The elevator system interface of claim 9, wherein
the processor is configured to determine the type of authorization of the user based on at least a voice signature of the user input or a predetermined authorization code of the user input, and
the at least one other secured feature includes a voice command or is accessible in response to a voice command.

11. A method of operating an elevator system interface, the method comprising:
receive audible input from a user at the interface;
determining a response to the audible input based on a content of the audible input and at least one other factor; and
providing at least an audible indication of the determined response through the interface.

12. The method of claim 11, comprising determining n at least one characteristic of the audible indication of the response selected from a set of characteristics consisting of a language, an accent, a speech tempo, and a volume.

13. The method of claim 12, comprising determining the at least one characteristic based on a corresponding characteristic of the audible input.

14. The method of claim 11, wherein the at least one other factor is a language of the audible input.

15. The method of claim 11, wherein the at least one other factor is a time or an event on a predetermined schedule.

16. The method of claim 11, wherein
the at least one other factor is a characteristic of a passenger request included in the audible input, and
the characteristic is selected from a set of characteristics consisting of a direction of travel, an origination floor, and an intended destination.

17. The method of claim 11, wherein
the at least one other factor includes a characteristic of the user; and
the characteristic of the user is selected from a set of characteristics consisting of a voice signature, a biometric feature of the user, an item carried by the user, and an item worn by the user.

18. The method of claim 11, wherein
the at least one other factor includes an authorization of the user, and
the method includes providing the user access to at least one secured feature of the elevator system corresponding to the authorization of the user.

19. The method of claim 18, comprising determining a type of authorization of the user and wherein
the type of authorization is one of an elevator system specialist, a building manager, and a priority passenger;
when the type of authorization is the elevator system specialist, the secured feature includes at least one of an elevator system function, information regarding performance of at least one portion of the elevator system, maintenance information, and control over at least one portion of the elevator system;
when the type of authorization is the building manager, the secured feature includes at least one of predetermined floor access, service information and customization options; and
when the type of authorization is the priority passenger, the secured feature includes at least one of priority elevator car assignment, predetermined floor access, a comfort feature, and an entertainment feature.

20. The method of claim 19, comprising determining the type of authorization of the user based on at least a voice signature of the user input or a predetermined authorization code of the user input, and wherein the at least one other secured feature includes a voice command or is accessible in response to a voice command.
